(19) United States
(12) Patent Application Publication
(10) Pub. No.: US 2025/0367759 A1
(43) Pub. Date: Dec. 4, 2025

(54) LASER PROCESS TO ENHANCE THE WIRE BONDING PROCESS

(71) Applicant: Turning Point Lasers Corporation., Hsinchu City (TW)

(72) Inventors: Szutsun Simon Ou, Taipei City (TW); Hung Sheng Lee, Taipei City (TW); Chi Luen Wang, Hsinchu City (TW); Han Wei Chang, Yunlin County (TW); Chung Cheng Lin, Chiayi County (TW)

(73) Assignee: Turning Point Lasers Corporation., Hsinchu City (TW)

(21) Appl. No.: 19/219,511

(22) Filed: May 27, 2025

(30) Foreign Application Priority Data
Jun. 4, 2024 (TW) 113120699

(51) Int. Cl. B23K 26/21; B23K 26/354; B23K 26/60; B23K 103/12

(52) U.S. Cl. CPC B23K 26/21; B23K 26/354; B23K 26/60; B23K 2103/12

(57) ABSTRACT

A laser process to enhance the wire bonding process, using before wire bonding, the laser process of the present invention uses a laser processing system to clean the surface oxide where the wire and the substrate are to be joint, then locally heated the substrate, then form a molten pool at the joint position, then uses the wire bonding to join the wire and the substrate. Laser cleaning of the substrate surface can reduce impurities at the bonding interface, and local heating to form the molten pool can make the metal easier to melt, thus reducing the resistance value after bonding and improving

### BACKGROUND OF THE INVENTION

### 1. Field of the Invention

The invention relates to a laser processing technology that is used for wire bonding in semiconductor packaging process, especially the one which reduces the formation of intermetallic compound and resistance value after bonding and improving conductivity, and can make the metal more easily melted.

### 2. Description of the Related Art

Wire bonding is a process technology in the semiconductor industry that uses metal wires to connect chips and lead frames. Wire bonding technologies are mainly thermocompression bonding, ultrasonic bonding, and thermosonic bonding. The metal wires used are mainly gold wires, silver wires, copper wires, aluminum wires, etc., but these wire bonding methods are all about laying the wires on the flat substrate, then using pressure, heat energy or ultrasonic vibration to form a physical combination of the substrate and the wire. Therefore, it is easy to produce an intermetallic compound (IMC) at the interface due to changes in stress and strain, and this IMC will not only cause an increase in resistance, but also affect long-term reliability. The use of mechanical and physical forced bonding also makes it difficult to reduce the contact area, and the radius size of the wire cannot be reduced, so encountering difficulties in manufacturing process in 3D packaging applications.

The generation of IMC affects the strength of the ball on the substrate, and is also the main cause of component failure caused by wire for a long time. When comparing the bonding lengths of copper and gold wires on aluminum substrates, it was found that copper wires are better. This is because the growth rate of IMC of copper on the aluminum substrate is lower than the growth rate of gold on the aluminum substrate. Therefore, how to restrain the growth of IMC is the most important step to obtain high reliability wiring. In order to slow down the generation of IMC, plasma cleaning can be used first during the wiring process (especially IC), Argon ion plasma cleaning can increase the bonding strength of gold and copper on the substrate, but it cannot completely solve the problem of IMC.

Compared with gold wires, copper wires have the advantage of low cost and better electrical conductivity, thermal conductivity and mechanical strength. Therefore, the wire diameter of copper bonding wires can be designed to be thinner and provide better heat dissipation efficiency. The current trend is to gradually replace traditional gold wires with copper wires and apply them to the wiring of semiconductor chips.

Referring to FIGS. 1A and 1B, the conventional wire bonding process of copper wires includes the following steps: first, provide a chip 11 and a substrate 12, the chip 11 has several pads 111 (such as aluminum pads), and the substrate 12 has several bond pads 121 (such as a copper pad), the substrate 12 carries the chip 11; then, a copper wire 14 is electronically ignited to form a solder ball through a solder pin 13 to form a ball end 141 (the first end), the solder pin 13 is used to heat-press the ball end 141 to the pad 111 of the chip 11; then, the solder pin 13 is moved to guide the copper wire 14 to the corresponding bond pad 121 of the substrate 12; finally, the copper wire 14 is thermally compressed and cut off on the bond pad 121 using the solder pin 13 to form a tail end 142 (the second end). However, it is found that an intermetallic compound (IMC) 15 will be formed between the front and rear ends of the copper wire 14 and the solder ball. As above mentioned, IMC will not only cause an increase in resistance, but also affect long-term reliability. The use of mechanical and physical forced bonding also makes it difficult to reduce the contact area, and the radius size of the wire cannot be reduced, so encountering difficulties in manufacturing process in 3D packaging applications.

### SUMMARY OF THE INVENTION

It is a primary objective of the present invention is to provide a laser process that is used for wire bonding in semiconductor packaging process, especially the one which reduces the formation of intermetallic compound and resistance value after bonding and improving conductivity and can make the metal more easily melted.

Another objective of the present invention is to provide a laser process that is used for wire bonding in semiconductor packaging process, especially the one which is suitable for copper wire, so as to have the advantage of low cost and better electrical conductivity, thermal conductivity and mechanical strength, also the wire diameter of copper wires can be designed to be thinner and provide better heat dissipation efficiency.

In order to achieve the above objectives, the laser process to enhance the wire bonding process of the present invention, the process steps comprising: a). Provide a laser processing system with a laser source; b). Provide a wire; c). Before wire bonding, use the laser processing system to clean the surface where the wire and a substrate are to be joined; d). Use the laser processing system, the laser source uses a blue laser with a laser source wavelength range of 400 nm to 500 nm, to form a molten pool at the joint position, the blue laser may include using 200 to 300 watts (W) of energy to locally heat the substrate for 2 to 3 milliseconds (ms), the molten pool is a circular concave arc with a maximum diameter of 330 μm to 360 μm and a maximum depth of 67 μm to 77 μm; and e). Finally, wire bonding is used to bond the wire to the substrate, so the wire is fused with the substrate, and after joining, the wire is higher than the substrate to form a ball, so that a joint end of the wire is completely covered in the molten pool.

Also, the laser source of laser processing system in step a). includes a fiber laser and a free space laser.

Also, the wire in step B). includes a copper wire.

Also, wherein the laser source of the laser processing system in step C). used for surface cleaning of the substrate includes a wavelength range 300 nm˜1100 nm.

With the features disclosed above, before wire bonding, the laser process of the present invention uses a laser processing system to clean the surface oxide where the wire and the substrate are to be joint, then locally heated the substrate, then form a molten pool at the joint position, then uses the wire bonding to join the wire and the substrate. Laser cleaning of the substrate surface can reduce impurities at the bonding interface, and local heating to form a molten pool can make the metal easier to melt, thus reducing the resistance value after bonding and improving conductivity.

### BRIEF DESCRIPTION OF THE DRAWINGS

FIG. 1A is a schematic diagram illustrating the conventional wire bonding;

FIG. 1B is a zoom in of the 1B in the FIG. 1A;

FIG. 2 is a block diagram illustrating the steps of a preferred embodiment of the present invention,

FIG. 3 is a schematic diagram showing the present invention uses the laser processing system to clean the surface;

FIG. 4 is a schematic diagram illustrating the present invention uses a laser to create a molten pool on the substrate surface;

FIG. 5 is a schematic diagram showing the bonding end of the wire is completely covered in the molten pool of the present invention;

FIG. 6 is a photograph showing the present invention uses an optical microscope (OM) to observe the wire bonding in the molten pool;

FIG. 7A is a sectional view of the present invention under a scanning electron microscope (SEM);

FIG. 7B is a schematic diagram showing the measurement in FIG. 7A.

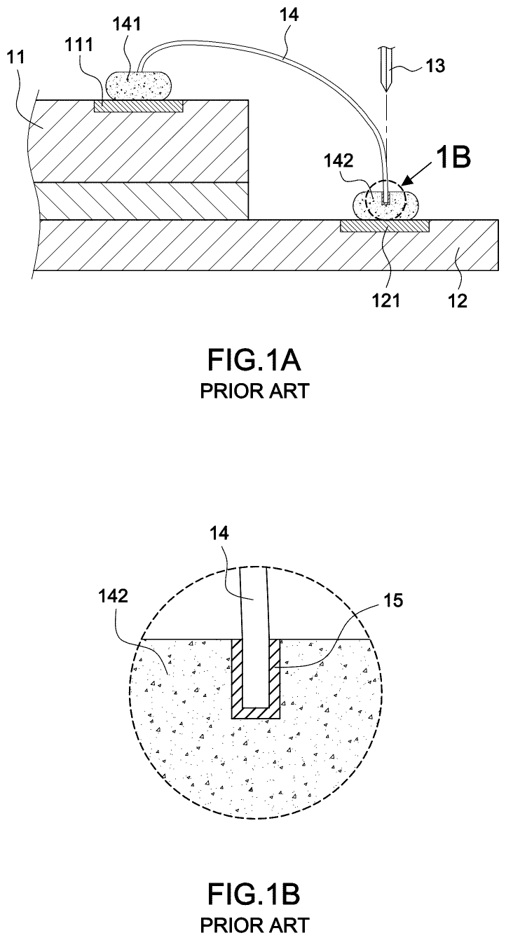

### DETAILED DESCRIPTION OF THE PREFERRED EMBODIMENT

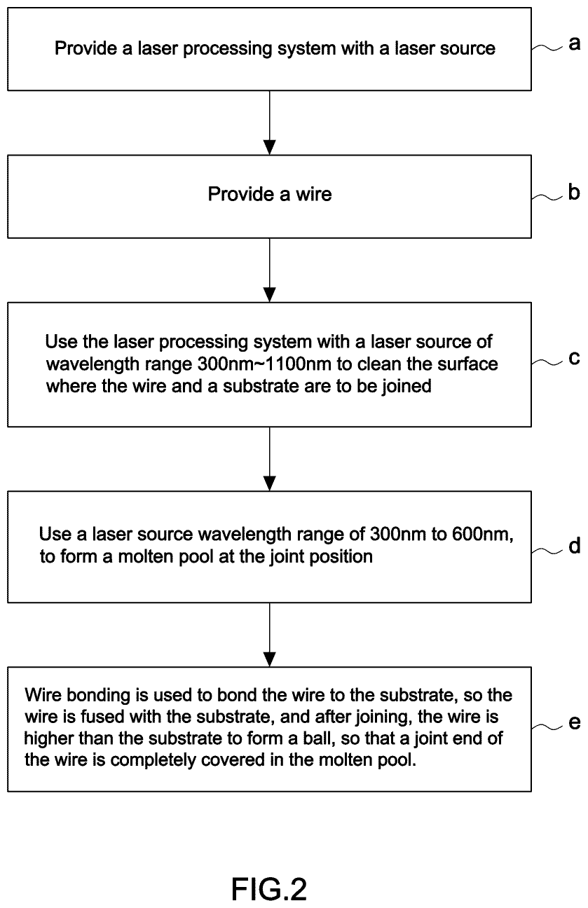

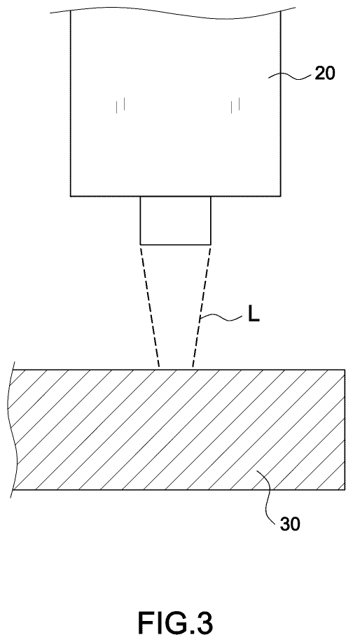

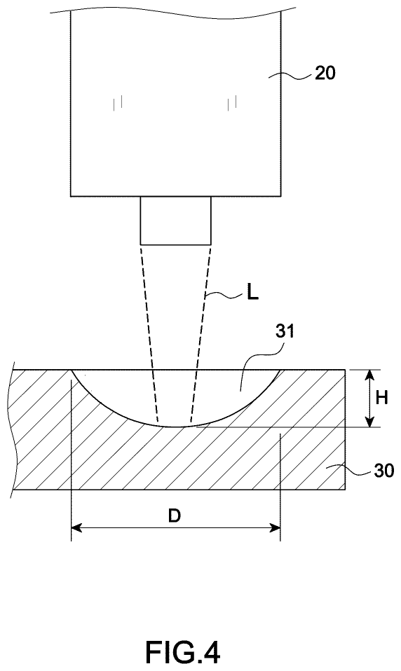

Referring to FIGS. 2˜5, a laser process to enhance the wire bonding process, the process steps comprising:
a). Provide a laser processing system with a laser source 20 to generate a laser light (L); in this embodiment, the laser source 20 of laser processing system includes a fiber laser and a free space laser, but the present invention is not limited to this.
b). Provide a wire 40; in this embodiment, the preferred wire 40 is a copper wire, but the present invention is not limited to this.
c). Before wire bonding, use the laser source 20 of the laser processing system to clean the surface where the wire 40 and a substrate 30 are to be joined; In this embodiment, due to the absorption rate of the wire 40 and the substrate 30 materials, a suitable laser source can avoid splashing and improve the process speed and wiring quality. For example, for common used wires 40 and substrates 30 metals such as Au, Cu, Ag and Al and their compounds, the wavelength range of the laser source used for surface cleaning of the substrate includes 300 nm˜1100 nm.
d). Use the laser processing system to use the laser light (L) of the laser source 20 to form a molten pool 31 at the joint position; In this embodiment, the wavelength range of the laser source 20 can be 300 nm to 600 nm laser light, and the appropriate wavelength can be selected according to the material of the substrate 30; and includes but is not limited to: 200 to 300 watts (W) of energy, locally heating the substrate 30 for about 2 to 3 milliseconds (ms), so that the molten pool 31 can be formed at the joint position. As for the laser selection, since silver, gold, copper and aluminum have poor absorption of IR lasers, generally is only about 5%. In this embodiment, the substrate 30 is made of copper, the substrate 30 can be locally heated by laser light with a wavelength of 300 nm to 600 nm to form a molten pool 31. Preferably, a blue laser with a wavelength of 400 nm to 500 nm is used.

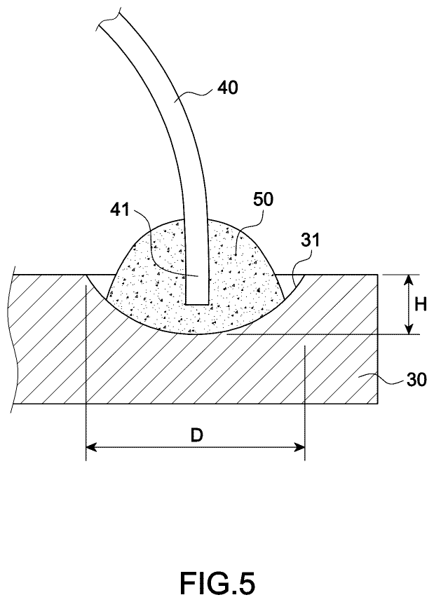

Due to the limitations of materials and manufacturing technology in the early stages of blue light semiconductor laser development, the power of a single blue light diode was limited by the size of the emission source area and could only output relatively low power. However, with the advancement of materials and development technology, the main semiconductor material used in blue laser diodes becomes gallium nitride (GaN). Benefiting from the maturity of micro-optical lens coupling technology and the applicant's continuous research and development of a system integrating blue laser diode laser output modules over the years, a blue laser source with high-power fiber output suitable for industrial applications has been created. Furthermore, the inventors have continuously tested and found that blue laser has extremely high stable absorption characteristics of the molten pool in the processing of non-ferrous metals (gold, silver, copper, aluminum), and its absorption rate can reach more than 65%. Therefore, as shown in FIG. 5, the present invention uses a blue laser with an energy of 200 to 300 watts (W) to locally heat the substrate 30 for about 2 to 3 milliseconds (ms) to form a molten pool 31 at the joint position.

In this embodiment, the molten pool 31 is a circular concave arc with a maximum diameter of 330 μm to 360 μm and a maximum depth of 67 μm to 77 μm; but not limited to this.
e). Finally, wire bonding is used to bond the wire 40 to the substrate 30, and after joining, the wire is higher than the substrate 30 to form a ball 50, so that a bonding end 41 of the wire 40 is completely covered in the molten pool 31.

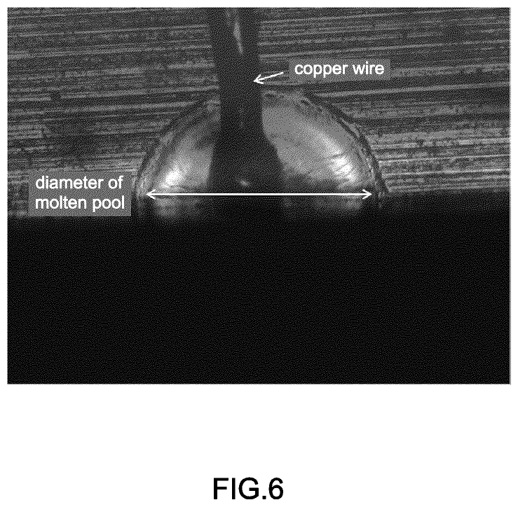

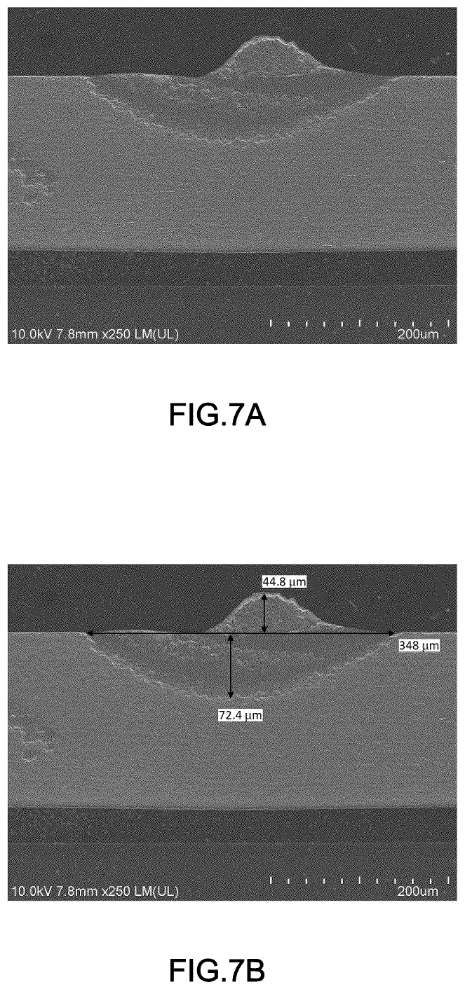

Referring to FIGS. 6, 7A and 7B, which disclose a photograph of the present invention using an optical microscope (OM) to observe the wire bonding in the molten pool, and a cross-sectional view of using a scanning electron microscope (SEM). The above pictures show that the present invention can indeed achieve the expected wire bonding state.

With the laser process mentioned above, the present invention uses a blue light laser to clean the surface of the substrate 30 first, then generates a molten pool 31 on the surface, and then wiring at the molten pool 31. Different from the conventional process, the present invention can predetermine the size of the molten pool 31 on the substrate 30 according to the possible depth and size of the wiring, in this way, the bonding end 41 of the entire wire 40 can be completely covered in the molten pool 31, unlike in the conventional process which only part of the surface was bonded to the substrate. Therefore, the new process of the present invention can make the bonding end 41 of the wire 40 completely covered by the molten pool 31, which can increase the bonding ability of the wire 40 and the substrate 30, because there is no need to force the wire 40 and the substrate 30 to be combined, so the probability of generating IMC will be greatly reduced.

With features disclosed above, although there are many ways to use lasers to enhance the bonding ability and strength of the wiring in the prior art, most of them are added during the wiring process. However, the method of the present invention is completely different from the prior art. The method of the present invention first creates a suitable molten pool 31 on the substrate 30 and then starts wiring, and blue laser has extremely high stable absorption characteristics of the molten pool in the processing of non-ferrous metals (gold, silver, copper, aluminum) materials. In this way, the metal easier to melt, thus reducing the resistance value after bonding and improving conductivity, and it is suitable for copper wire, so as to have the advantage of low cost and better electrical conductivity, thermal conductivity and mechanical strength, also the wire diameter of copper wires can be designed to be thinner and provide better heat dissipation efficiency.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A laser process to enhance the wire bonding process, the process steps comprising:
a). Provide a laser processing system with a laser source;
b). Provide a wire;
c). Before wire bonding, use the laser processing system to clean the surface where the wire and a substrate are to be joined;
d). Use the laser processing system, the laser source uses a blue laser with a laser source wavelength range of 400 nm to 500 nm, to form a molten pool at the joint position, the blue laser includes using 200 to 300 watts (W) of energy to locally heat the substrate for 2 to 3 milliseconds (ms), the molten pool is a circular concave arc with a maximum diameter of 330 μm to 360 μm and a maximum depth of 67 μm to 77 μm; and
e). Finally, wire bonding is used to bond the wire to the substrate, so the wire is fused with the substrate, and after joining, the wire is higher than the substrate to form a ball, so that a joint end of the wire is completely covered in the molten pool.

2. The laser process to enhance the wire bonding process as claimed in claim 1, wherein the laser source of laser processing system in step a). includes a fiber laser and a free space laser.

3. The laser process to enhance the wire bonding process as claimed in claim 1, wherein the wire in step b). includes a copper wire.

4. The laser process to enhance the wire bonding process as claimed in claim 1, wherein the laser source of the laser processing system in step c). used for surface cleaning of the substrate includes a wavelength range 300 nm˜1100 nm.
